(19) United States
(12) Patent Application Publication
(10) Pub. No.: US 2026/0165521 A1
(43) Pub. Date: Jun. 18, 2026

(54) EXTENDABLE CURTAIN TRACKS

(71) Applicant: LOVELIGHT PTY LTD, South Yarra, VIC (AU)

(72) Inventors: Jason LEWIS, Victoria (AU); Anthony JIMENEZ, Victoria (AU)

(21) Appl. No.: 19/129,598

(22) PCT Filed: Nov. 15, 2023
(86) PCT No.: PCT/IB2023/061515

§ 371 Date: May 13, 2025

(30) Foreign Application Priority Data
Nov. 15, 2022 (AU) 2022903429

(51) Int. Cl. A47H 1/04; E06B 9/06; E06B 9/13; E06B 9/36; E06B 9/58

(52) U.S. Cl. CPC A47H 1/04; E06B 9/0692; E06B 9/13; E06B 9/36; E06B 9/58

(57) ABSTRACT

An extendable curtain track, comprising an inner profile that telescopes longitudinally within an outer profile, and curtain runners that slide longitudinally within the inner and outer profiles. The inner and outer profiles are configured so that the curtain runners slide longitudinally on the inner profile and the outer profile without catching on overlapping portions of the inner and outer profiles.

### FIELD

The present invention generally relates to extendable curtain tracks.

### BACKGROUND

Curtain tracks (or headrails) are commonly provided in standard lengths which must be cut down to length to fit a particular window width. Extendable curtain tracks have also been proposed that generally comprise a pair of hollow poles or rods which telescope one inside the other.

Existing extendable curtain tracks suffer several shortcomings. There is an internal vertical step between the pair of poles where they overlap. Curtains frequently jam because the curtain runners catch or snag on the internal vertical step as they slide longitudinally between overlapping portions of the telescopic poles.

In view of this background, there is an unmet need for improved extendable curtain tracks which avoid or minimise the above disadvantages.

### SUMMARY

According to the present invention, there is provided an extendable curtain track, comprising:
an inner profile that telescopes longitudinally within an outer profile; and
curtain runners that slide longitudinally within the inner and outer profiles;
wherein the inner profile has a lower internal edge defined by a pair of spaced apart L-shaped flanges inwardly facing one another;
wherein the outer profile has a lower internal edge defined by a pair of spaced apart squared J-shaped flanges inwardly facing one another;
wherein each curtain runner has an upper internal edge defined by a pair of spaced apart inverted squared J-shaped flanges outwardly facing away from one another;
wherein the L-shaped flanges of the inner profile slide longitudinally within the squared J-shaped flanges of the outer profile; and
wherein the inverted squared J-shaped flanges of each curtain runner respectively slide longitudinally on the L-shaped flanges of the inner profile and the squared J-shaped flanges of the outer profile without catching on overlapping portions of the inner and outer profiles.

The inner and outer profiles may be elongate with a hollow, generally rectangular cross-section shape.

Each curtain runner may have a lower internal edge defined by a pair of spaced apart L-shaped flanges outwardly facing away from one another below the squared J-shaped flanges of the outer profile.

Each curtain runner may further comprise a vertical shaft extending between the lower internal edge and the upper internal edge, wherein the vertical shaft has rounded or bevelled leading and trailing surfaces to smooth sliding transitions between the overlapping portions of the inner and outer profiles.

The extendable curtain track may further comprise one or more filler profiles that slide on the inner profile and are spaced apart from the outer profile and one another, wherein each filler profile has a lower internal edge defined by an inwardly facing L-shaped flange, and wherein each filler profile has a front side surface with a shape and size that are the same as a front side surface of the outer profile.

The extendable curtain track may further comprise a fascia profile that covers front side surfaces of the filler and outer profiles.

The fascia profile may have a squared C-shape cross-section.

The extendable curtain track may further comprise end caps that fit over ends of the filler, fascia, and outer profiles.

The end caps may act as stops to longitudinally retain the curtain runners within the inner and outer profiles.

An access notch may be provided through the squared J-shaped flanges at one end of the outer profile so that an excess number of the curtain runners can be removed through the access notch leaving a required number of the curtain runners within the inner and outer profiles between the end caps.

The access notch may be removably covered by a notch clip that fits into the end cap at the one end of the outer profile after the excess number of the curtain runners have been removed.

The fascia, filler, inner, and outer profiles may comprise extrusions of metal or rigid plastic. The metal may, for example, comprise aluminium.

The curtain runners, end caps, and notch clip may comprise mouldings of plastic.

### BRIEF DESCRIPTION OF DRAWINGS

Embodiments of the invention will now be described by way of example only with reference to the accompanying drawings, in which:

FIG. 1 is an exploded perspective view of an extendable curtain track according to an embodiment of the present invention;

FIG. 2 is an assembled perspective view of the extendable curtain track;

FIGS. 3 and 4 are perspective views of the inner and outer profiles of the extendable curtain track in retracted and extended positions, respectively;

FIGS. 5 to 7 are end views of the inner, outer, and filler profiles, respectively;

FIG. 8 is a cross-section view through the inner and outer profiles;

FIG. 9 is a cross-section view through the inner and filler profiles;

FIGS. 10 and 11 are perspective and front views of a curtain runner;

FIG. 12 is a longitudinal cross-section perspective view through the curtain runner, and inner and outer profiles;

FIG. 13 is a cross-section view through the curtain runner, and inner and outer profiles; and FIGS. 14 to 17 are partial bottom perspective views of the extendable curtain track showing sequential removal of excess curtain runners through an access notch in one end of the outer profile.

### Description of Embodiments

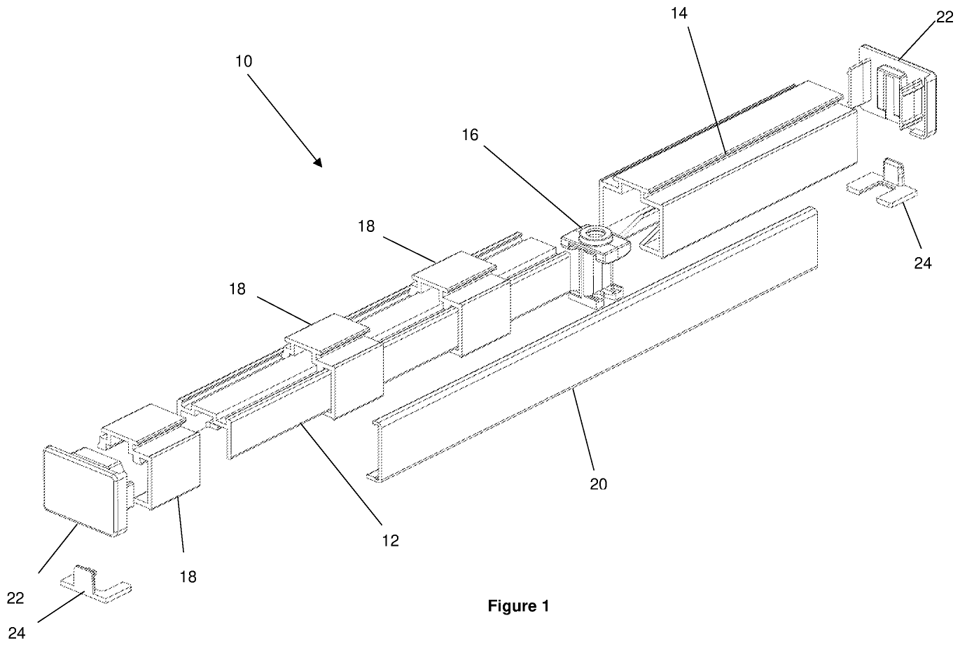

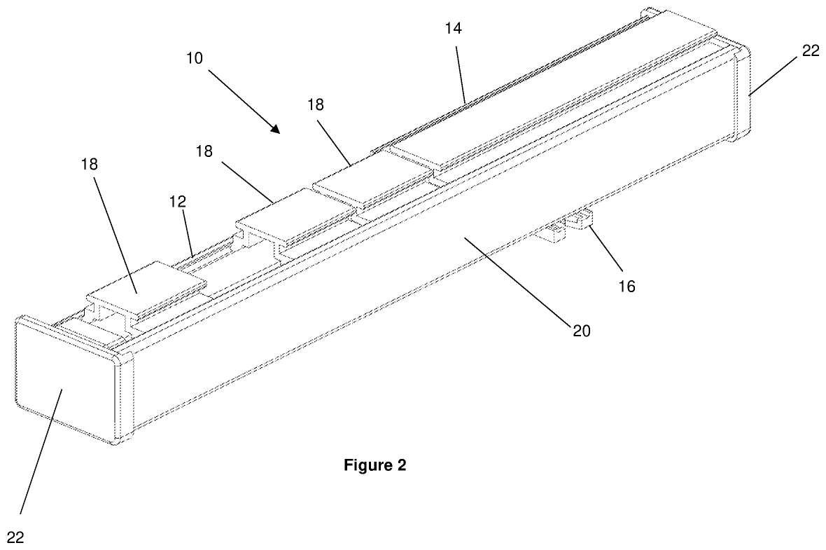

Referring to FIGS. 1 to 3, an extendable curtain track 10 according to an embodiment of the present invention may generally comprise an inner profile 12 that telescopes longitudinally within an outer profile 14. The inner and outer profiles 12, 14 may, for example, be elongate with a hollow, generally rectangular cross-section shape.

Curtain runners 16 (only one is shown for clarity) may slide longitudinally within the inner and outer profiles 12, 14. Filler profiles 18 may slide on the inner profile 12 and be spaced apart from the outer profile 14 and one another. Each filler profile 18 may have a front side surface with a shape and size that are the same as a front side surface of the outer profile 14. A fascia profile 20 may cover front side surfaces of the filler and outer profiles 18, 14. The fascia profile 20 may, for example, have a squared C-shape cross-section.

End caps 22 may fit over ends of the filler, fascia, and outer profiles 18, 14, 20. The end caps 22 may each have inwards-facing tongues that fit inside the ends of the filler and outer profiles 18, 14. The end caps 22 may act as stops to longitudinally retain the curtain runners 16 within the inner and outer profiles 12, 14. Notch clips 24 may fit into the end caps 22 to cover lower openings or notches in the inner and outer profiles 12, 14. The notch clips 24 may each have a upwards-facing tongue that fits inside a pair of spaced apart L-shaped flanges inwardly facing one another inside each end cap 22.

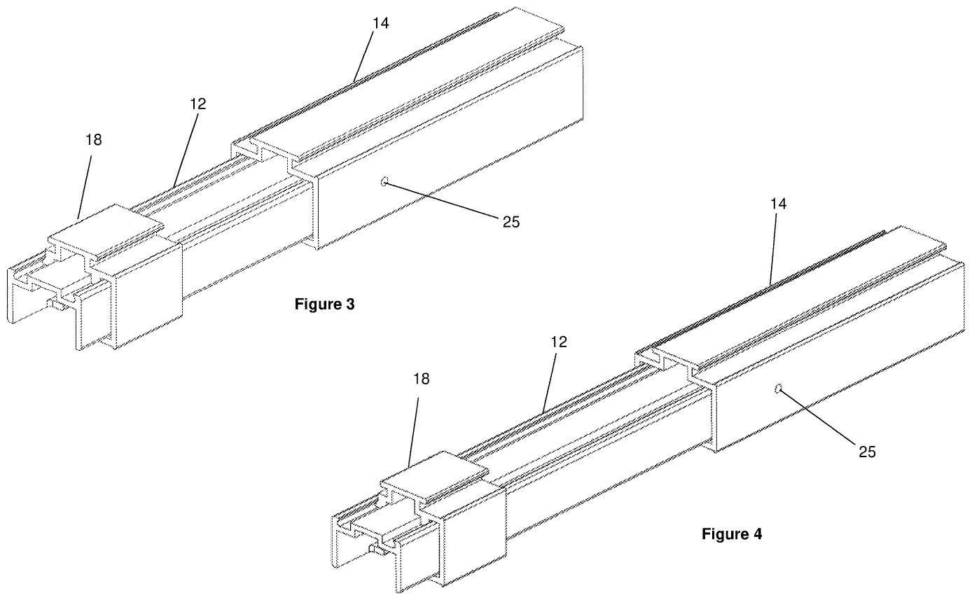

As shown in FIGS. 3 and 4, in use, the inner profile 12 may be telescopically longitudinally slidable or movable relative to the outer profile 14 from a retracted position to an extended position so as to provide the extendable curtain track 10 with different overall lengths to fit different widths of windows or curtains. The inner and outer profiles 12, 14 may be secured to one another at a desired overall length by a grub screw (not shown) that is threadably received in a grub screw hole 25 provided through the outer profile 14. The fascia profile 20 may be cut down to a length corresponding to the overall length of the inner and outer profiles 12, 14 in the extended position. In addition, the inner and outer profiles 12, 14 may be provided in different individual lengths so that the extendable curtain track 10 with different overall lengths. The extendable curtain track 10 may be mounted to a window frame or wall by brackets (not shown).

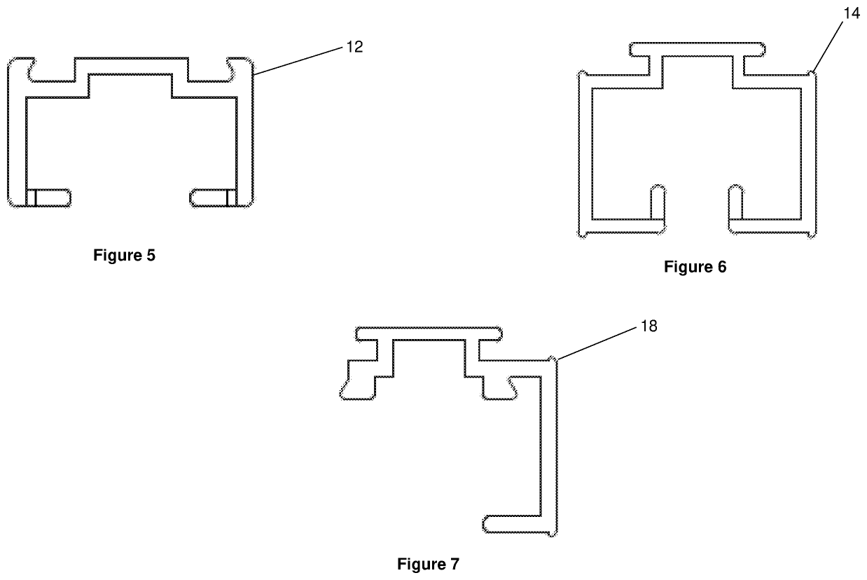

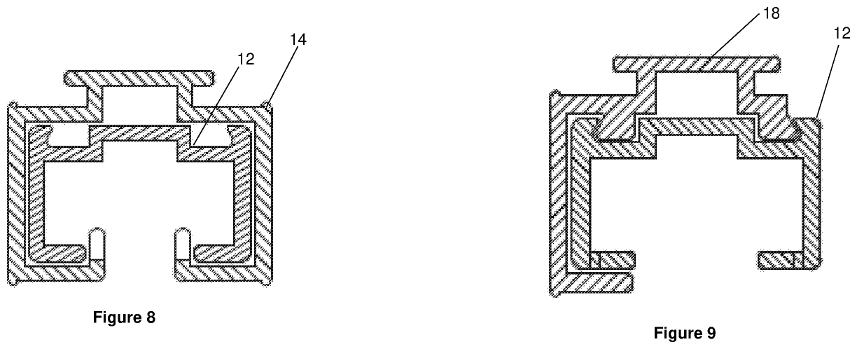

Referring to FIGS. 5 to 9, in one embodiment the inner profile 12 may have a lower internal edge defined by a pair of spaced apart L-shaped flanges inwardly facing one another, and an upper external edge defined by spaced apart grooves. The outer profile 14 may have a lower internal edge defined by a pair of spaced apart squared J-shaped flanges inwardly facing one another. As shown in FIG. 8, in use, the L-shaped flanges of the inner profile 12 may slide longitudinally within the squared J-shaped flanges of the outer profile 14.

The filler profile 18 may have a lower internal edge defined by an inwardly facing L-shaped flange, and an upper internal edge defined by spaced apart projections. As shown in FIG. 9, in use, the L-shaped flange of the filler profile 18 may slide longitudinally outside the squared J-shaped flanges of the inner profile 12, and the spaced apart projections of the filler profile 18 may slide in the spaced apart grooves of the inner profile 12.

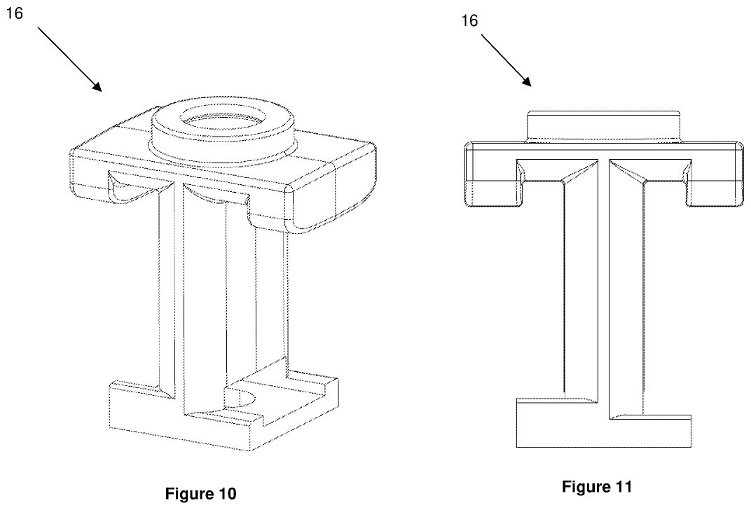

As shown in FIGS. 10 and 11, in one embodiment each curtain runner 16 may have an upper internal edge defined by a pair of spaced apart inverted squared J-shaped flanges outwardly facing away from one another. Each curtain runner 16 may further have a lower internal edge defined by a pair of spaced apart L-shaped flanges outwardly facing away from one another below the squared J-shaped flanges of the outer profile 14. In addition, each curtain runner 16 may comprise a vertical shaft extending between the lower internal edge and the upper internal edge, wherein the vertical shaft has rounded or bevelled leading and trailing surfaces to smooth sliding transitions between overlapping portions of the inner and outer profiles 12 and 14. The shape, size and configuration of the free-hanging lower portion of the curtain runner 16 may be varied to accommodate different types of connections for mounting curtains, vertical blinds, or other window furnishings.

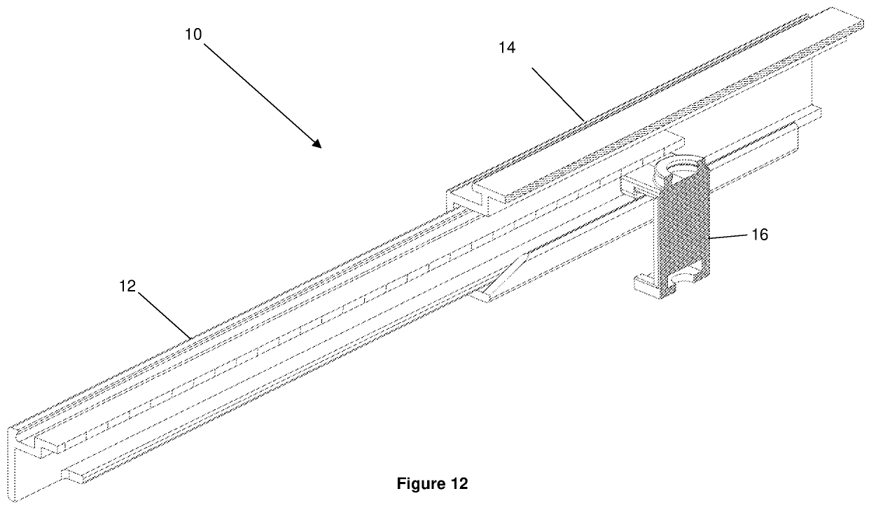

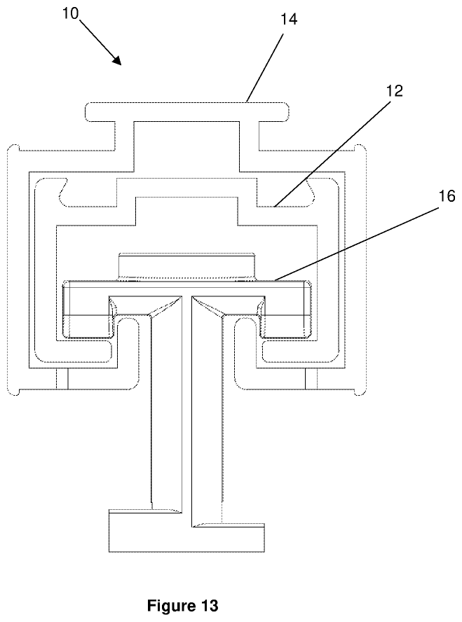

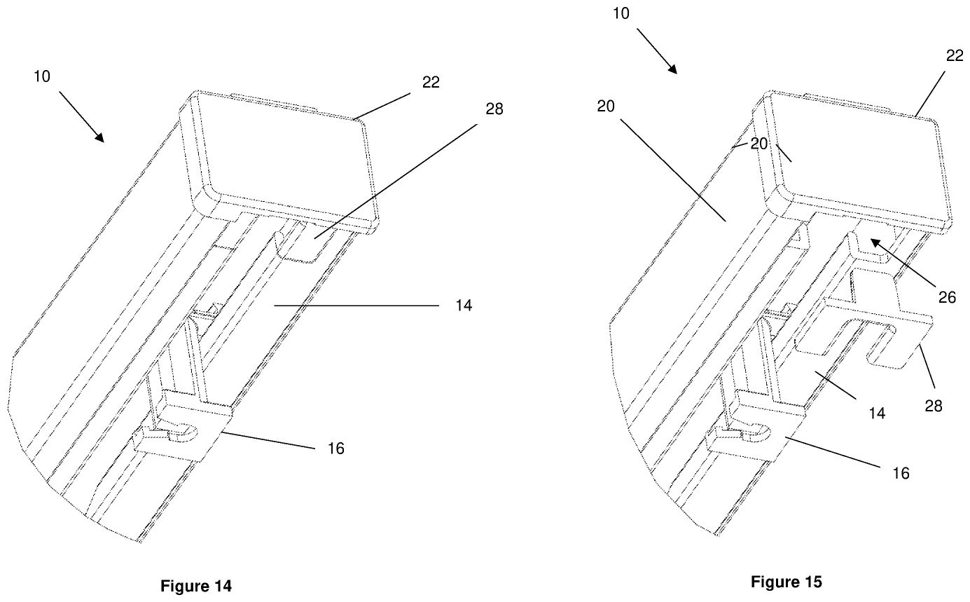

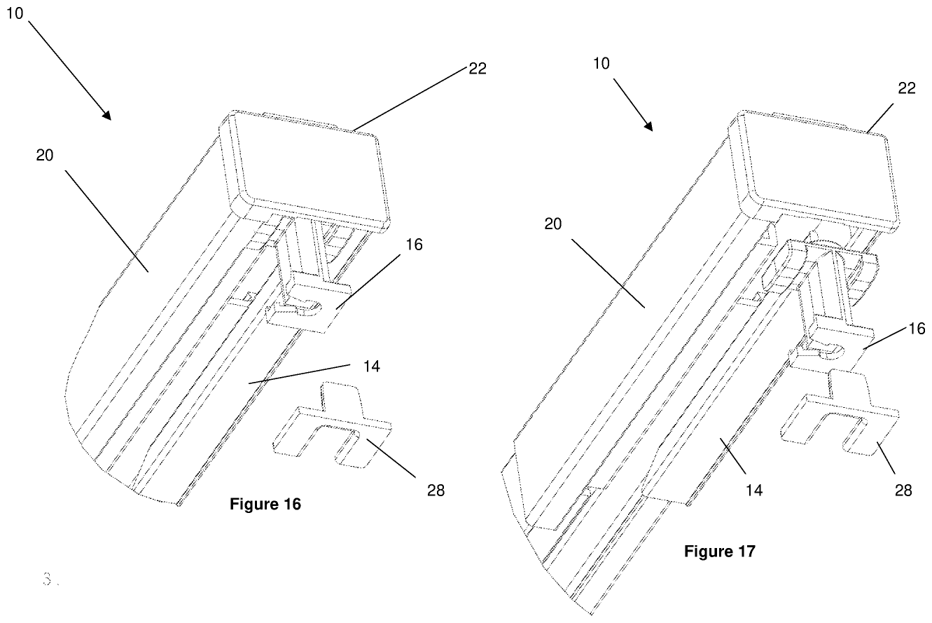

As shown in FIGS. 12 and 13, in use, the inverted squared J-shaped flanges of each curtain runner 16 may respectively slide longitudinally on the L-shaped flanges of the inner profile 12 and the squared J-shaped flanges of the outer profile 14 without catching or snagging on overlapping portions of the inner and outer profiles 12 and 14.

Referring to FIGS. 14 to 17, an access notch 26 may be provided through the squared J-shaped flanges at one end of the outer profile 14 so that an excess number of the curtain runners 16 can be removed through the access notch 26 leaving a required number of the curtain runners 16 within the inner and outer profiles 12, 14 between the end caps 22. The access notch 26 may be removably covered by one of the notch clips 24 that fits into the end cap 22 at the one end of the outer profile 12 after the excess number of the curtain runners 16 have been removed.

The fascia, filler, inner, and outer profiles 20, 18, 12, 14 may comprise, for example, extrusions of metal or rigid plastic. The metal may, for example, comprise aluminium. The curtain runners 16, end caps 22, and notch clips 24 may, for example, comprise mouldings of plastic.

Embodiments of the present invention provide an extendable curtain track that is both generally and specifically useful for windows of different widths.

Although the embodiments of the present invention have been described by way of example only as “extendable curtain tracks,” it will be appreciated that the present invention may also be implemented with equal success as extendable tracks for vertical blinds or other types of window furnishings.

Unless the context requires otherwise, the word “comprising” means “including but not limited to,” and the word “comprises” has a corresponding meaning.

Any reference to prior art is not an admission that the prior art is common general knowledge.

The scope of the invention supported by the above examples is defined by the claims that follow.

1. An extendable curtain track, comprising:
an inner profile that telescopes longitudinally within an outer profile; and
curtain runners that slide longitudinally within the inner and outer profiles;
wherein the inner profile has a lower internal edge defined by a pair of spaced apart L-shaped flanges inwardly facing one another;
wherein the outer profile has a lower internal edge defined by a pair of spaced apart squared J-shaped flanges inwardly facing one another;
wherein each curtain runner has an upper internal edge defined by a pair of spaced apart inverted squared J-shaped flanges outwardly facing away from one another;
wherein the L-shaped flanges of the inner profile slide longitudinally within the squared J-shaped flanges of the outer profile; and
wherein the inverted squared J-shaped flanges of each curtain runner respectively slide longitudinally on the L-shaped flanges of the inner profile and the squared J-shaped flanges of the outer profile without catching on overlapping portions of the inner and outer profiles.

2. The extendable curtain track of claim 1, wherein the inner and outer profiles are elongate with a hollow, generally rectangular cross-section shape.

3. The extendable curtain track of claim 1, wherein each curtain runner has a lower internal edge defined by a pair of spaced apart L-shaped flanges outwardly facing away from one another below the squared J-shaped flanges of the outer profile.

4. The extendable curtain track of claim 3, wherein each curtain runner further comprises a vertical shaft extending between the lower internal edge and the upper internal edge, and wherein the vertical shaft has rounded or bevelled leading and trailing surfaces to smooth sliding transitions between the overlapping portions of the inner and outer profiles.

5. The extendable curtain track of claim 1, further comprising one or more filler profiles that slide on the inner profile and are spaced apart from the outer profile and one another, wherein each filler profile has a lower internal edge defined by an inwardly facing L-shaped flange, and wherein each filler profile has a front side surface with a shape and size that are the same as a front side surface of the outer profile.

6. The extendable curtain track of claim 5, further comprising a fascia profile that covers front side surfaces of the filler and outer profiles.

7. The extendable curtain track of claim 6, wherein the fascia profile has a squared C-shape cross-section.

8. The extendable curtain track of claim 6, further comprising end caps that fit over ends of the filler, fascia, and outer profiles.

9. The extendable curtain track of claim 8, wherein the end caps act as stops to longitudinally retain the curtain runners within the inner and outer profiles.

10. The extendable curtain track of claim 1, wherein an access notch is provided through the squared J-shaped flanges at one end of the outer profile so that an excess number of the curtain runners can be removed through the access notch leaving a required number of the curtain runners within the inner and outer profiles between the end caps.

11. The extendable curtain track of claim 10, wherein the access notch is removably covered by a notch clip that fits into the end cap at the one end of the outer profile after the excess number of the curtain runners have been removed.

12. The extendable curtain track of claim 6, wherein the fascia, filler, inner, and outer profiles comprise extrusions of metal or rigid plastic.

13. The extendable curtain track of claim 11, wherein the curtain runners, end caps, and notch clip comprise mouldings of plastic.
